(19) United States
(12) Patent Application Publication
(10) Pub. No.: US 2010/0154086 A1
(43) Pub. Date: Jun. 17, 2010

(54) NOVEL ENHANCED PROCESSES FOR MOLECULAR SCREENING AND CHARACTERIZATION

(75) Inventors: Eric Henderson, Ames, IA (US); Curtis Mosher, Huxley, IA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: BioForce NanoSciences Holdings, Inc.

(21) Appl. No.: 11/776,511

(22) Filed: Jul. 11, 2007

Related U.S. Application Data
(60) Provisional application No. 60/830,315, filed on Jul. 11, 2006.

(51) Int. Cl. G01Q 60/24

(52) U.S. Cl. 850/33

(57) ABSTRACT

A general high-throughput screening (HTS) process using an atomic force microscope (AFM) to detect and measure molecular recognition events. The AFM is used to measure changes in molecular complex height, friction, shape, elasticity or any other relevant parameters that report a molecular recognition event. In addition, the force involved in molecular recognition and bonding is directly measured using the technique of force spectroscopy. In one embodiment, a flow chamber is used to introduce molecules and assay their effect on a molecular interaction occurring between molecules on the AFM probe and a surface. In some cases the surface may be an introduced microparticle. In a second embodiment, the sample is a solid phase array of molecules that is interrogated by a functionalized AFM probe, and the effects of introduced agents at each molecular address in the array is measured by force spectroscopy.

### RELATED APPLICATION

This application claims the benefit of and priority to U.S. Provisional Application Ser. No. 60/830,315, filed 11 Jul. 2006, the contents of which are incorporated by reference herein in its entirety.

### BACKGROUND OF THE DISCLOSURE

The present disclosure relates to practical applications of tools and systems comprising nanotechnology. In particular, the present disclosure relates to high-throughput screening techniques, processes and products thereby, using atomic force microscopy.

Interactions between molecules is a central theme in living systems. These interactions are key to myriad biochemical and signal transduction pathways. Such pathways in turn dictate the status of the overall system. Slight changes in the interactions between biomolecules can result in inappropriate development, cancer, a variety of disease states, and even cell senescence and death. On the other hand, it can be extremely beneficial to develop reagents that can inhibit, stimulate, or otherwise effect specific types of molecular interactions. These effectors often become very powerful drugs used to treat a variety of conditions.

### SUMMARY OF THE DISCLOSURE

A general high-throughput screening (HTS) process using an atomic force microscope (AFM) to detect and measure molecular recognition events. The AFM is used to measure changes in molecular complex height, friction, shape, elasticity or any other relevant parameters that report a molecular recognition event. In addition, the force involved in molecular recognition and bonding is directly measured using the technique of force spectroscopy. In one embodiment, a flow chamber is used to introduce molecules and assay their effect on a molecular interaction occurring between molecules on the AFM probe and a surface. In some cases the surface may be an introduced microparticle. In a second embodiment, the sample is a solid phase array of molecules that is interrogated by a functionalized AFM probe, and the effects of introduced agents at each molecular address in the array is measured by force spectroscopy.

According to a feature of the present disclosure, a process is disclosed comprising, in combination providing an atomic force microscopy (AFM) system for measuring molecular force interactions having at least a biological probe; functionalizing the at least a biological probe; and generating at least a data set further comprising a force curve analysis using a third molecule.

According to a feature of the present disclosure, a process is disclosed comprising, in combination providing an AFM system for measuring molecular force interactions having at least one biological probe, functionalizing the at least one biological probe, and generating at least a data set further comprising a probe resonance analysis using a third soluble molecule.

According to a feature of the invention, a set of data or content is produced by the processes of the instant disclosure.

According to a feature of the invention, a product by the various processes is described herein.

### BRIEF DESCRIPTION OF THE FIGURES

The above-mentioned features and objects of the present disclosure will become more apparent with reference to the following description taken in conjunction with the accompanying drawings wherein like reference numerals denote like elements and in which:

FIG. 1 shows a schematic description of an AFM according to the teachings of the present disclosure;

FIG. 2 likewise schematically illustrates operational aspects of the system according to the present disclosure, including the instant optical deflector mechanism.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, biological, electrical, functional, and other changes may be made without departing from the scope of the present invention. The following detailed description is, therefore, not to be taken in a limiting sense, and the scope of the present invention is defined only by the appended claims. As used in the present disclosure, the term “or” shall be understood to be defined as a logical disjunction and shall not indicate an exclusive disjunction unless expressly indicated as such or notated as “xor.”

Significant to the high-throughput aspects of this invention are novel approaches including the interrogation of molecular arrays by these processes. The procedures described here have the added benefit of allowing the measurement of changes in molecular binding events upon change of analysis environment or addition of additional effector molecules to the assay system. In one embodiment, this process is carried out in a flow through format in which the effector molecules are soluble and flowed into and out of the analysis chamber. In this way, large numbers of effector molecules can be sequentially screened for their effect on a single molecular interaction in a short period of time. The processes described herein are extremely useful in the search for compounds, such as new drugs, for treatment of undesirable physiological conditions. Likewise, biologics and complexes of molecules heretofore uncontemplated are within the ambit and scope of the instant teachings.

Numerous studies have shown that the atomic force microscope (AFM) can be used to explore and measure molecular interactions by making a variety of measurements, including direct measurement of the forces involved in the interaction between molecules on the AFM probe and molecules immobilized on a surface (references 1 & 2, and other references therein). These studies constitute significant prior art clearly illustrating that it is possible to readily and directly measure the forces acting between and within individual molecules of all types.

This disclosure develops a process for detecting and measuring molecular recognition events which comprises a combination of providing an AFM system for measuring molecular force interactions having a biologically functionalized probe and generating at least a data set that comprises a force curve analysis using a third soluble competitor molecule.

The present inventors have discovered that it is possible to use a novel approach, gauging of molecular complex formation and disruption forces and energies, to measure changes in molecular complex formation caused by the addition of an additional, soluble molecular species. The disclosure described here is a method for using an AFM in a high throughput format and exploiting its ability to make these measurements to detect and evaluate interactions between molecules, among other similar uses.

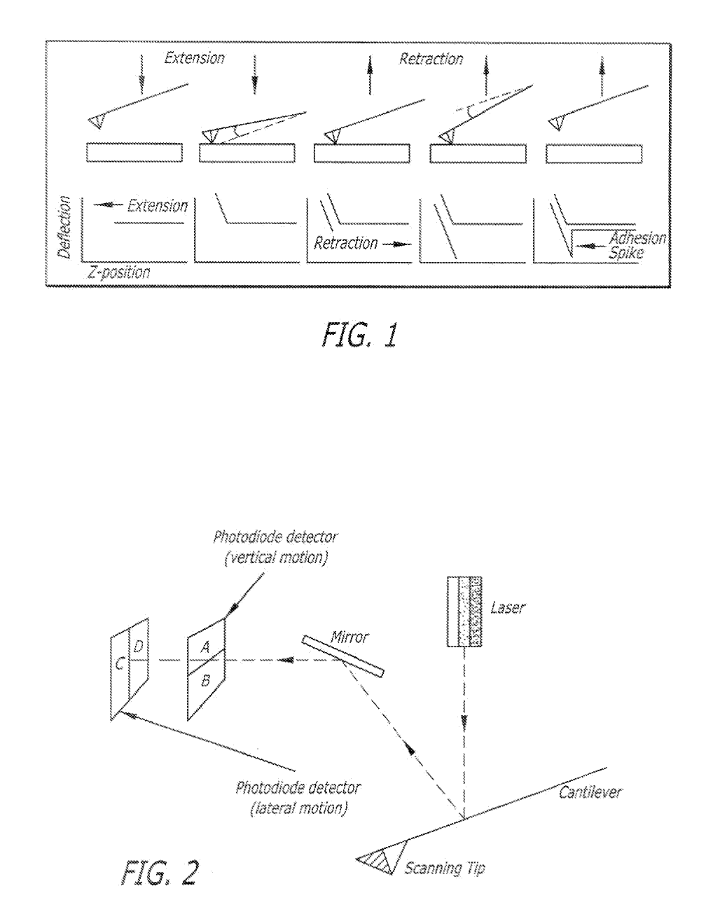

Noteworthy is that force vs. distance analysis (see FIG. 1) provides a platform to achieve data and content as set forth herein. Further, integrating this approach with either solid phase molecular arrays or controlled, multi-analyte fluidic feeds, is disclosed. Finally, the processes described herein utilize resonance-based analytical methods in the high throughput format described herein.

Referring to FIG. 1, there is illustrated a force vs. distance analysis. This is the basic method for measuring inter- and intra-molecular forces. As the tip approaches the surface during the extension portion of the cycle the cantilever is deflected. Then, as the tip is pulled away, the adhesive force resulting from molecular interactions causes the cantilever to deflect past its resting position until the restoring force of the cantilever is sufficient to rupture the adhesive bond. Since the spring constant of the cantilever is known, the molecular adhesive force can be calculated with high precision. An additional parameter—cantilever resonance—can also be monitored and serve as an indicator of interactions between the modified AFM probe and the surface with which it is interacting.

Turning now to FIG. 1, there is shown schematically an AFM and a flexible lever (cantilever) with a sharp probe at the end, shown being scanned over a sample, generating a topography of the sample's surface with molecular and even atomic resolution. A variety of measurements can be made in the AFM including, topography (height), friction, and elasticity or compressibility. In addition, the AFM can make extremely fine force measurements. Movements of the cantilever in the nanometer to angstrom to sub-angstrom range can result in measurement of nanonewton (nN) to piconewton (pN) forces. This level of force falls within the range of forces involved in molecular interactions. Thus, the AFM is capable of measuring forces between individual molecular pairs. Changes in AFM probe resonance can also report forces and other phenomena with ultrafine precision. Thus, use of the AFM in “DC” (force measurement) or “AC” (resonance measurement) modes is according to embodiments of the present disclosure. Also, thermal resonance (rather than resonance driven by an external inducer) can be employed in the practice of the present disclosure. It is noteworthy that forces can be measured in both parts of the force curve cycle. Thus, a binding force may be measured as well as a rupture or unbinding force. The binding force may be indicative of both long range (through space) interactions and molecular bond formation interactions. Thus, this invention may exploit binding or unbinding measurements to analyze the effect of third molecules on the interactions between a defined molecular system.

Turning now to FIG. 2, a schematic of an AFM, using an optical detection mechanism, is shown. Deflections in the cantilever result in the movement of a laser beam impinging on a split photodiode detector. This results in a change in the output voltage from the photodiode which is proportional to the deflection of the cantilever. This is a popular method for detecting cantilever motion. Alternative methods also exist and may be suitable in embodiments of the present disclosure. These include, but are not limited to: capacitance, piezoresistance, magnetic force, and interferometry.

### Force Spectroscopy

Expressly incorporated by reference herein are U.S. Pat. Nos. 5,992,226; 5,958,701; 5,874,660; and 5,372,930, as if the same were fully set forth herein.

According to an aspect of the instant teachings, during force spectroscopy (F-SPEC) mode, the AFM probe is functionalized with a molecule of interest. This bio- or chemi-active probe is then allowed to interact with a surface and the force interactions are measured. This measurement is typically displayed as a force vs. distance curve (“force curve”). To generate a force curve, the tip or sample is cycled through motions of vertical extension and retraction, (see also FIG. 2). Each cycle brings the tip into contact with the sample, then pulls the tip out of contact.

The displacement of the cantilever is zero until the extension motion brings the tip into contact with the surface. Then the tip and sample are physically coupled as the extension continues. The cycle is then reversed and the tip is pulled away from the sample. If there is no attractive interaction between the tip and sample the tip separates from the sample at the same position in space at which they made contact during extension. However, if there is an adhesive interaction between the tip and sample during retraction, the cantilever will bend past its resting position and continue to bend until the restoring force of the cantilever is sufficient to rupture the adhesive force. In a force curve this adhesive interaction is represented by an “adhesion spike” (FIG. 1). Since the spring constant of the probe is known, the adhesive force (the unbinding force) can be precisely determined.

Several features of F-SPEC make it particularly noteworthy, including:

Real time data acquisition—Since data are collected and displayed in real time the operator has the opportunity to immediately evaluate data and molecular interactions. Furthermore, real time effects of changes in the molecular environment can be monitored. Thus, in contrast to many existing analytical methods, one can evaluate the effects of inhibitors or other effector molecules immediately upon perturbation of the system.

High data density—The data set generated by AFM is extremely information dense. It contains information about the binding force, mode of binding, elasticity of the binding pocket, and denaturation-renaturation potential. Furthermore, this method allows one to potentially identify variations in molecular populations that would not be revealed by methods involving averaged signals.

Low concentration of reactants—The concentration of reactants can be extremely low. In fact, theoretically, only one molecular pair is necessary to make measurements by AFM, although practically speaking a sufficient number of molecules may be needed in embodiments to allow rapid location of molecular species on the sample surface.

Direct measurement—the AFM method is a direct measurement technique. The molecules under scrutiny are directly tethered to the signal transducing device (the probe). Therefore, there are few moving parts involved other than the molecular system and the mechanical transducer. This results in few sources for introduction of error or complicating factors. Importantly, the measurement made is a direct reporter of the molecular interaction under scrutiny, not a constant that represents the ratio of bound to unbound states (a binding constant). This is important because the direct force measurement may contain valuable information that is masked in equilibrium values like a binding constant derived from a measurement involving thousands to millions of molecules or more. It is noteworthy that despite the differences in these types of measurements, they can be related mathematically, thereby providing an intellectual and practical conduit connecting force and binding constant data sets.

1. Force Measurements

In one approach to making molecular force measurements, the AFM probe is functionalized with a molecule of interest. This bio- or chemi-active probe is then allowed to interact with a surface to which relevant molecular species are bound and the force interactions are measured. This measurement is typically displayed as a force vs. distance curve (“force curve”). To generate a force curve, the tip or sample is cycled through motions of vertical extension and retraction (FIG. 2). Each cycle brings the tip into contact with the sample, then pulls the tip out of contact. The displacement of the cantilever is zero until the extension motion brings the tip into contact with the surface. Then the tip and sample are physically coupled as the extension continues. The cycle is then reversed and the tip is pulled away from the sample. If there is no attractive interaction between the tip and sample, the tip separates from the sample at the same position in space at which they made contact during extension. This process may be repeated many times to obtain an average force value if desired.

If there is an adhesive interaction between the tip and sample during retraction, the cantilever will bend past its resting position and continue to bend until the restoring force of the cantilever is sufficient to rupture the adhesive force. In a force curve this adhesive interaction is represented by an “adhesion spike.” Since the spring constant of the probe is known, the adhesive force (the unbinding force) can be precisely determined. Upon careful inspection of a typical adhesion spike, many small quantal unbinding events are frequently seen. The smallest unbinding event that can be evenly divided into the larger events can be interpreted as representing the unbinding force for a single molecular pair.

In some cases a “jump to contact” may be observed. This can be mediated by long range forces (e.g., electrostatic) but may also be the result of initial molecular binding followed by restructuring of the binding to achieve the final, stable molecular interactive state. Again, by measuring the degree of cantilever deflection that occurs during this process valuable information may be obtained about the initial binding event.

Both intra- and inter-molecular forces can be measured by the AFM. Intermolecular forces have been measured between receptor/ligand nucleic acid and protein/protein systems in the art. Intramolecular forces have also been measured in proteins and polysaccharides, with one of the most phenomenal demonstration to date being the observation of unbinding events in individual IgG domains within a single molecule of the muscle protein titin. In this study the unbinding force curve for titin contained a saw-tooth pattern, resulting from sequential rupture of multiple IgG domains. This saw-tooth intramolecular unbinding pattern is a diagnostic signature for the titin protein. Thus, it is possible that with refined electronics and a stable mechanical system one may measure individual elements of a global binding event. In other words, the binding (or unbinding) pathway may be measured, giving the investigator information about the details of the molecular contacts and other parameters associated with inter and intramolecular interactions.

As mentioned previously, known work suggests that as instrumentation and methods improve, it will be possible to extract from mechanical denaturation experiments discrete force spectra. These spectra will contain information about the atomic contacts holding the molecules together. Thus, we will learn to interpret the signature generated by a mechanical denaturation experiment with regard to the internal structure of the molecule. An example of the utility of this approach would be comparison of wildtype and mutant forms of a protein or DNA molecule. The force signature will reveal how that mutation affects the stability, and possibly function, of the molecule under study. This method has the potential to make tremendous contributions to the understanding of the molecular components involved in forming and stabilizing inter- and intra-molecular interactions.

2. Height, Friction and Elasticity Measurements

The AFM is capable of measuring changes in height in the sub nanometer range. Thus, if the height of a molecule is measured, then a second molecule binds to it, the change of height is sufficient to be detected easily by AFM. Experiments of this type have been carried out and show that antibody/antigen complexes can be measured in this way. In addition to the change in height, the general change in shape of the complex can also be used as an indicator of molecular binding.

Friction is measured by monitoring the change in lateral displacement of the AFM probe as it scans a surface. Higher friction results in greater displacement. In the context of molecular recognition, if the formation of a molecular complex results in a local change in frictional coefficient, this can be detected on the nanometer scale by a change in lateral displacement of the AFM probe as it scans over the complex. Thus, local changes in frictional coefficient can be used to report molecular recognition events.

The local elasticity or compressibility of a surface can be measured in several ways using the AFM. In one case the AFM probe is pushed into the surface, and the relative spring constant of the surface compared to that of the probe is measured. If this value changes upon formation of a molecular complex, the local elasticity can be used to report this molecular recognition event. In another approach, the AFM probe is oscillated at or near its resonance frequency. Resonance parameters, including amplitude, frequency and phase, are measured.

Changes in these parameters are extremely sensitive to variations in the interaction between the probe and the surface. If the local elasticity or viscosity of the surface changes, there is a shift in the phase parameter, resulting in a report of the surface change. Thus, this approach can be used to detect molecular recognition events if they result in a change in local elasticity.

3. Probe Modification

For making the type of measurements described herein, it is generally necessary to confer biological functionality on standard AFM probes. This procedure is accomplished by one of two general strategies. In the first approach a functionalized microparticle is physically bonded to the AFM cantilevers to generate relatively dull probes with large numbers of apical molecules. Bonding can be mediated by glue (e.g., epoxy) or by other methods such as local microwelding. The second approach is use of a surface chemistry including, but not limited to, alkanethiolate silane, crown ether, or dendrimer self-assembling monolayer approaches to create a chemically defined and reactive surface. Coupling of this surface to biological materials of interest produces sharp AFM probes with relatively few apical molecules.

4. Antibody Systems

The general protocol, intended to be illustrative but not limiting, for the process described herein is to establish a tip/sample force interaction as described above (i.e., a force curve analysis or resonance analysis) and then titrate into the system competitors, enhancers, or inhibitors to further define the nature of the force interaction. Antibodies provide a useful, but not limiting, example. In the case of antibody-based analyses the tests can be divided into two general classes. One class involves direct interaction between antibody on the probe and antigen on the surface, in which case excess antibody or antigen will compete with probe/sample interaction. In a second class, the same antibody is on the probe and sample surface, while the antigen is in solution. When the antigen is trapped between antibodies on the two surfaces, a trimolecular sandwich is formed. This interaction can be diminished by addition of excess antigen, which saturates the binding sites of probe and surface antibodies, thereby preventing them from forming a tripartite structure that can generate a rupture force. This is analogous to the competition approach contemplated for drug screening. In the latter, the two components of a relevant molecular pathway are tethered to the AFM probe and surface, and the third molecule is a candidate drug that in some way (e.g., inhibits) effects the interaction between the tethered molecules.

Surface modification. As mentioned above there are many methods for tethering molecules to AFM probes and surfaces. One method is to use a self-assembling alkanethiolate procedure. In this approach the surface is modified with a 3 nm of chromium followed by 30 nm of gold using an ion beam sputterer. The surface is next treated with an alkanethiolate terminating with a carboxyl group. This forms a self assembling monolayer, creating an acidic surface. The carboxyl groups are then coupled to primary amines on the antibodies (or antigens, which are generally also antibodies in most of our test systems) by condensation mediated by a carbodimide (e.g., 1-Ethyl-3-[3-dimethylaminopropyl]carbodiimide hydrochloride EDAC). A variation of this method is to use an alkanethiolate terminating in a succinimide group, which can then be spontaneously coupled to primary amines on the biomolecule to be immobilized. These methods produce biomolecular surfaces that are active. In a second approach, antibodies are coupled to protein G immobilized on a surface. This surface may be chemically activated or may be native, in which case the protein G adheres by physisorption. The antibody is first added to the particle and complexed by the Fc region with the protein G. Then, if desired, the antibody and protein G are then crosslinked using a homobifunctional reagent (dimethyl pimelimidate, DMP, Pierce Chemicals) to form a covalent complex. A potential advantage of this protocol is that the antibodies are presented with the active sites distal to the point at which they are coupled to the matrix, thereby enhancing the percentage of active antibodies on the surface.

Force measurements on microparticles. In one embodiment of the current invention, the interactions between antibodies and antigens mentioned above are carried out on the surface of a microparticle. In one preferred embodiment, the surface is that of a superparamagnetic microparticle. This is directly relevant to the large numbers of methods employing superparamagnetic particles for separations and analyses. It is particularly relevant that construction of combinatorial libraries is often carried out on particles, providing a framework for development of methods for screening large numbers of particles for those coupled to candidate molecules.

Superparamagnetic particles coupled to antibodies or antigens are flowed into an analysis chamber. The particles are temporarily immobilized by application of a magnetic field using either a rare earth stator magnet, or an electromagnet.

In some experiments, the lateral stability of the immobilized particles is increased by depositing them into small pits or grooves appropriate for the size of the particles on the bottom of the flow chamber.

These pits may be created using a proprietary plasma etch process developed for modification of AFM tips and sample surfaces. Other methods for creating pits include, but are not limited to, laser drilling, laser ablation, electron beam lithography, microlithography, nanolithography, and localized chemical etching. To carry out the screening process on these surfaces the probe is positioned over individual immobilized superparamagnetic particles and force spectra acquired. Alternatively, resonance measurements are made. After force or resonance (DC or AC) interrogation, the magnetic field will be released and the particles removed from the chamber. Again, this approach anticipates a flow through strategy for screening large numbers of surface immobilized molecules.

5. Avidin-Biotin

The avidin biotin system has been extensively characterized by force spectroscopy. This aspect of the system allows those skilled to plan and carry out experiments essentially as previously described, with minor variations. One relevant variation will be the use of microtiter plates coated with NeutraAvidin (Pierce Chemicals). In preliminary experiments we have observed that these plates are excellent substrates for interactions with biotin functionalized AFM probes. Exemplary, but not limiting, alternative substrates include agarose beads, gold surfaces coated with biotin or avidin terminated alkanethiolate monolayers land polystyrene microparticles coupled to avidin or biotin. An advantage of using these various substrates is that they have different local elastic properties. The agarose beads are very soft and compliant, while the monolayer is relatively stiff, and the styrene polymer is intermediate between the two. This will allow us to test the requirement for soft surfaces in acquiring F-SPEC data.

To carry out these studies, avidin-biotin binding forces are established by conventional force curve acquisition. After acquiring force spectra for the avidin-biotin molecular pair, the system is saturated with soluble biotin to definitively show that the binding forces observed were specifically derived from the avidin-biotin complex. The data collected may be compared to that already reported, and the various surfaces compared to gain insight regarding the optimal physical configuration for acquisition of force spectroscopy data sets.

6. Protein-DNA

Explorations of protein/DNA interactions by force spectroscopy may provide invaluable information. Studies of this nature were completed using a well defined protein/DNA molecular pair: the DNA binding protein Ga14 (a yeast transcription factor) and its target sequence (5′-CGGAAGACTCTCCTCCG-3′). In these experiments, the protein and DNA are tethered to either the tip or the surface to be studied by methods analogous to those already described. Briefly, a concatameric, amino terminated DNA molecule is tethered to COOH terminated surfaces using a carbodiimide condensation reagent (e.g., EDAC). This produces a surface with the DNA tethered at one end and extending away from the surface sufficiently far to allow binding by the Ga14 protein. The protein used in these studies is a fusion between Ga14 and Glutathione-S-Transferase (GST). The fusion protein was designed to place the Ga14 binding domain distal from the amino terminus, allowing coupling through the amino terminus to surfaces and leaving the DNA binding domain as far away from the surface as possible to maximize stereochemical freedom. Gel shift analyses show that this protein retains DNA binding capability and sequence specificity.

In preliminary experiments, the adhesion forces observed for the Ga14-DNA molecular pair were significantly greater than those observed using functionalized probes containing non-DNA binding protein. These experiments may be repeated to generate a large enough data set to allow a statistically robust interpretation of the data. Control experiments may be performed in which excess soluble DNA or Ga14 will be titrated into the flow chamber and the suppression of binding events compared with changes observed in experiments in which irrelevant DNA or protein species are introduced. As with the experiments described above, samples may be tested both on fixed and microparticle surfaces. Data may be analyzed and displayed using a graphical output (rather than numerical) which gives the user an immediate appreciation of the key features of a data set. We have developed such software and call it ForceScape©.

7. Intramolecular DNA

Recent studies have dramatically demonstrated the ability of force spectroscopy to reveal information about intramolecular force interactions. To expand upon this type of study one may use this approach to examine a large DNA molecule and to explore how its intramolecular structure is altered upon binding by exogenous factors (e.g., proteins). In one test case, the DNA molecule contained the Gal4 binding domain repeated many times and was generated by standard PCR (polymerase chain reaction) methods. This DNA molecule may be covalently attached to a surface, and transiently attached to the probe using a biotin/avidin linkage. The biotin avidin bond should be sufficiently strong to allow mechanical denaturation of the large molecule and measurement of the intra-molecular binding forces in the duplex portions. Then, as we extend the molecule, the biotin/avidin bond will break, terminating that cycle, but allowing subsequent cycles of analysis. Since the test molecule contains repeated palindromic sequence elements, it can fold into a number of configurations. Thus, we anticipate acquiring a variety of force curve signatures that contain a minimal rupture force corresponding to rupture of a single hairpin.

After careful analysis of the force spectra obtained with the DNA system alone, one may titrate soluble Ga14 protein into the system. We anticipate in this case a change in the rupture signature corresponding to the change in binding energy contributed by the protein as it embraces the DNA. By comparing the spectra for the naked DNA and the protein/DNA systems, we have created a force spectroscopy approach to protein DNA analysis that is data rich. The task for future studies will be to learn how to interpret this data with regard to generating useful information about how the protein is binding to the DNA, and what changes can be observed when altered (mutant) protein or DNA components are used. Again, AC methods (resonance) may be important and contribute to evolution of the deepest data set possible.

The following examples serve to illustrate aspects of the disclosure described herein. They are not intended to limit the scope of the disclosure and are merely to exemplify the uses of the present invention.

### Example 1

Protein-protein interactions with soluble third species. Enhanced Flow capability in these examples is featured throughout.

### Example 2

Receptor-ligand interaction in an array format.

### Example 3

Single molecule force spectroscopy with additional effector molecules.

### Example 4

Screening on particles (paramagnetic etc.). In many cases it will be desirable to flow into the chamber a population of superparamagnetic microparticles coupled to test molecules. These particles must be temporarily immobilized to allow accurate force spectroscopy measurements to be made. To accomplish this, a magnet will be positioned directly under the imaging chamber. Both an electromagnet design and a stator magnet design will be evaluated. The electromagnet will be activated after introduction of the particles, causing them to adhere strongly to the chamber bottom. The stator magnet will be mechanically positioned to immobilize the particles. Force spectroscopy measurements will then be taken at desired positions. After data acquisition, the magnetic field will be released and the particles removed by fluid flow or lateral magnetic force. At this point, the next batch of particles to be examined can be introduced. An interesting and potentially useful possibility that will be investigated is the recovery of individual particles that had a distinguishing force spectrum using the AFM probe as an ultra precise micromanipulation device. In this case, the particle would be bound to the tip, the other particles removed, then the bound particle recovered and further analyzed. This is directly relevant to combinatorial library screens in which a candidate molecule on the isolated microparticle has been tagged with a specific molecular feature, allowing its identification after the initial screening process.

### Example 5

Using changes in height on antibody arrays.

### Example 6

Force spectroscopy of protein G-antibody interaction and antibody antigen interactions. Effects of soluble competitors.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A process comprising, in combination:
providing an atomic force microscopy (AFM) system for measuring molecular force interactions having at least a biological probe;
functionalizing the at least a biological probe; and
generating at least a data set further comprising a force curve analysis using a third molecule.

2. The process of claim 1, the molecular force interactions further comprising at least one of intramolecular and intermolecular forces.

3. The process of claim 1, comprising measuring effects of introduced agents on molecular interactions.

4. The process of claim 1, further comprising using height and shape changes in molecular complexes to generate at least one of data points, end points and intermediate data structures.

5. The process of claim 1, further comprising factoring in frictional changes in molecular complexes.

6. The process of claim 1, further comprising measuring elasticity changes in molecular complexes.

7. The process of claim 1, further comprising using direct molecular force measurements.

8. The process of claim 1, further comprising the immobilized molecules being moieties from at least one of nucleic acids, proteins, lipids, sugars, other organic molecules and moieties, and inorganic molecules or moieties.

9. The process of claim 3, wherein the introduced agent is at least one of an organic compound, an inorganic compound, a molecule, and a biomolecule.

10. The process of claim 3, wherein the agent is at least one of an inhibitor, an enhancer, an attenuator, and a modulator, or a pharmacologically active agent.

11. A process comprising, in combination:
providing an AFM system for measuring molecular force interactions having at least one biological probe;
functionalizing the at least one biological probe; and
generating at least a data set further comprising a probe resonance analysis using a third soluble molecule.

12. The process of claim 11, the molecular force interactions further comprising at least one of intra molecular and intermolecular forces.

13. The process of claim 11, comprising measuring effects of introduced agents on molecular interactions.

14. The process of claim 11, further comprising using height and shape changes in molecular complexes to generate at least one of data points, end points and intermediate data structures.

15. The process of claim 11, further comprising factoring in frictional changes in molecular complexes.

16. The process of claim 11, further comprising measuring elasticity changes in molecular complexes.

17. The process of claim 11, further comprising using direct molecular force measurements.

18. The process of claim 11, further comprising the immobilized molecules being moieties selected from the group of, nucleic acids, proteins, lipids, sugars, organic and inorganic chemical groups.

19. The process of claim 13, wherein the introduced agent is at least one of an atomic species, an organic compound, and an inorganic compound.

20. The process of claim 13, wherein the introduced agent is at least one of a molecule, a biomolecule, an inhibitor, an inhibitor, an enhancer, an attenuator, and a modulator.
